(19) United States
(12) Patent Application Publication
(10) Pub. No.: US 2004/0244923 A1
(43) Pub. Date: Dec. 9, 2004

(54) Shade

(75) Inventors: Tung-Hsin Chen, Yungkang City (TW); Yih-Wenn Luo, Anping Chiu (TW); Chun-Chao Lin, Tainan (TW); Huei-Jung Hsieh, Dali City (TW)

Correspondence Address: NIKOLAI & MERSEREAU, P.A., 900 SECOND AVENUE SOUTH, SUITE 820, MINNEAPOLIS, MN, 55402, US

(73) Assignees: Tung-Hsin Chen, Yungkang City (TW); Yih-Wenn Luo, Anping Chiu (TW)

(21) Appl. No.: 10/810,968

(22) Filed: Mar. 26, 2004

(30) Foreign Application Priority Data
May 6, 2003 (TW) 092208383

(51) Int. Cl. B60J 1/20

(52) U.S. Cl. 160/370.21

(57) ABSTRACT

A foldable shade having a four-sided shape comprises an elongated, magnetic base having a section of U, a plurality of parallel slats wherein each of the odd numbered slats includes a plurality of longitudinal grooves adjacent either side, and two pairs of a plurality of projections, each pair being disposed between the grooves and the side, and each of the even numbered slats includes a plurality of longitudinal projections adjacent either side, and two pairs of a plurality of grooves, each pair being disposed between the projections and the side; and a plurality of suction cups fixedly provided at the slat farthest from the base. The slat next to the base is inserted therein. In a folded state the grooves of each of the remaining slats are inserted in the projections of the immediate next slat proximate the base.

### BACKGROUND OF THE INVENTION

1. Field of the Invention

The present invention relates to shades and more particularly to such a shade with improved characteristics.

2. Description of Related Art

Shades have many applications including as window shades of an automobile, indoor partitions, etc. Also, there have been numerous suggestions in prior art about shades. However, prior shades are typically relatively complex in constructions, costly to manufacture, trouble-prone, and unreliable in use. Also, they are troublesome to manipulate or operate. Further, some of them are visually unattractive. Thus, the need for improvement still exists.

### SUMMARY OF THE INVENTION

It is an object of the present invention to provide a foldable shade having a four-sided shape, comprising an elongated base formed of a magnetic material having a section of U; a plurality of parallel slats wherein each of the odd numbered slats includes a plurality of longitudinal grooves adjacent either side, and two pairs of a plurality of projections, each pair being disposed between the grooves and the side, and each of the even numbered slats includes a plurality of longitudinal projections adjacent either side, and two pairs of a plurality of grooves, each pair being disposed between the projections and the side; and a plurality of suction cups fixedly provided at the slat farthest from the base, wherein the slat next to the base is inserted therein and in a folded state the grooves of each of the remaining slats are operative to insert in the projections of the immediate next slat proximate the base for engagement.

It is another object of the present invention to provide a foldable shade having a four-sided shape, comprising an elongated base formed of a magnetic material having a section of U; a plurality of parallel slats wherein each slat includes a plurality of longitudinal grooves adjacent either side and each slat except the slat next to the base further includes a plurality of snapping elements; and a plurality of suction cups fixedly provided at the slat farthest from the base, wherein the slat next to the base is inserted therein and in a folded state either snapping element of the even numbered slat is fastened at the lowest end of the outer projection thereof and the highest end of the outer projection of the immediate next slat proximate the base and either snapping element of the odd numbered slat is fastened at the lowest end of the inner projection thereof and the highest end of the inner projection of the immediate next slat proximate the base.

The above and other objects, features and advantages of the present invention will become apparent from the following detailed description taken with the accompanying drawings.

### BRIEF DESCRIPTION OF THE DRAWINGS

FIG. 1 is an exploded view of a first preferred embodiment of shade according to the invention;

FIG. 2 is a perspective view of the assembled shade in FIG. 1;

FIG. 3 is an exploded view of a second preferred embodiment of shade according to the invention;

FIG. 4 is a perspective view of the assembled shade in FIG. 3 with an enlarged view of the area in circle A;

FIG. 5 is an environmental view of the shade according to the first preferred embodiment being mounted on the windshield of an automobile;

FIG. 6 is another environmental view of the shade according to the first preferred embodiment being mounted on the windshield of an automobile;

FIG. 7 is an environmental view of the shade according to the first preferred embodiment being mounted on the window of an automobile;

FIG. 8 is an environmental view of the shade according to the first preferred embodiment being mounted on the window of a house as a window shade;

FIG. 9 is an environmental view of the shade according to the first preferred embodiment being used as an indoor folding partition; and

FIG. 10 is an environmental view of the shade according to the second preferred embodiment being mounted between the window and the side of the roof of an automobile.

### DETAILED DESCRIPTION OF THE PREFERRED EMBODIMENTS

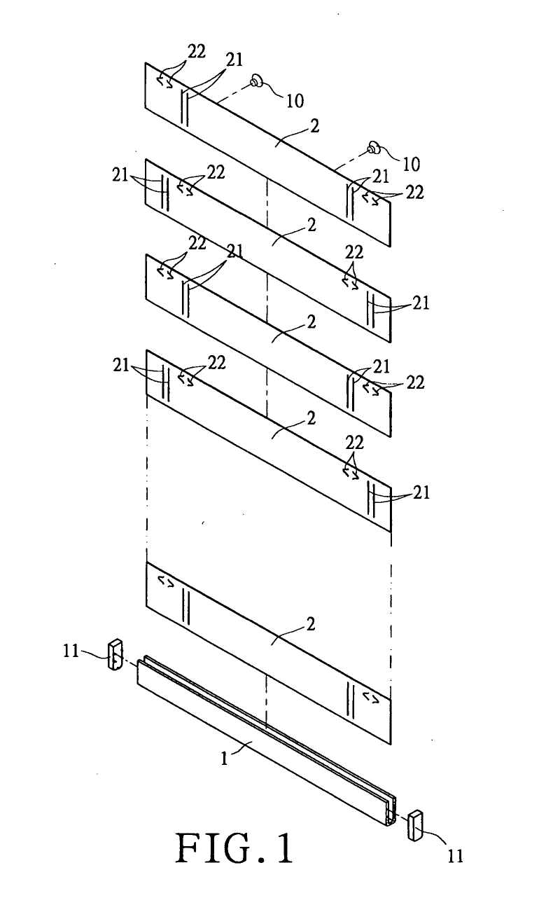

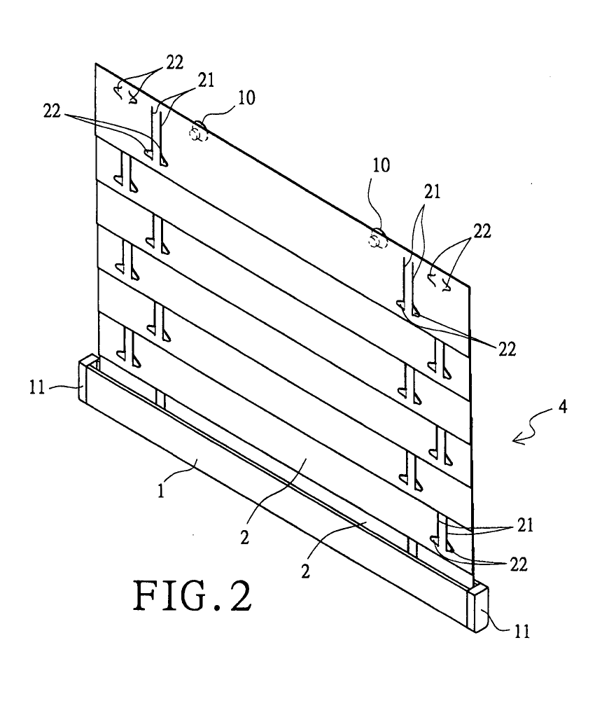

Referring to FIGS. 1 and 2, there is shown a rectangular, foldable shade constructed in accordance with a first preferred embodiment of the invention. The shade comprises a base 1 at one end, a plurality of parallel slats 2, and a plurality of (e.g., two) suction cups 10 fastened at the slat 2 farthest from the base 1. Each component will be described in detail below.

The base 1 is an elongated member having a section of U. The base 1 comprises two caps 11 snapped to ends thereof. The base 1 is formed of a magnetic material so as to be adapted to attract iron, steel, etc. The slats 2 are arranged alternately in which each of the odd numbered slats 2 comprises a plurality of (two are shown) longitudinal grooves 21 adjacent either side, and two pairs of a plurality of (e.g., two) projections 22, each pair being disposed between the grooves 21 and the side, and each of the even numbered slats 2 comprises a plurality of (two are shown) longitudinal projections 22 adjacent either side, and two pairs of a plurality of (e.g., two) grooves 21, each pair being disposed between the projections 22 and the side. In a folded state, the lowest slat 2 is inserted into the slot of the base 1 while the grooves 21 of each of the remaining slats 2 are inserted into the projections 22 of immediate lower slat 2 (if any) for engagement.

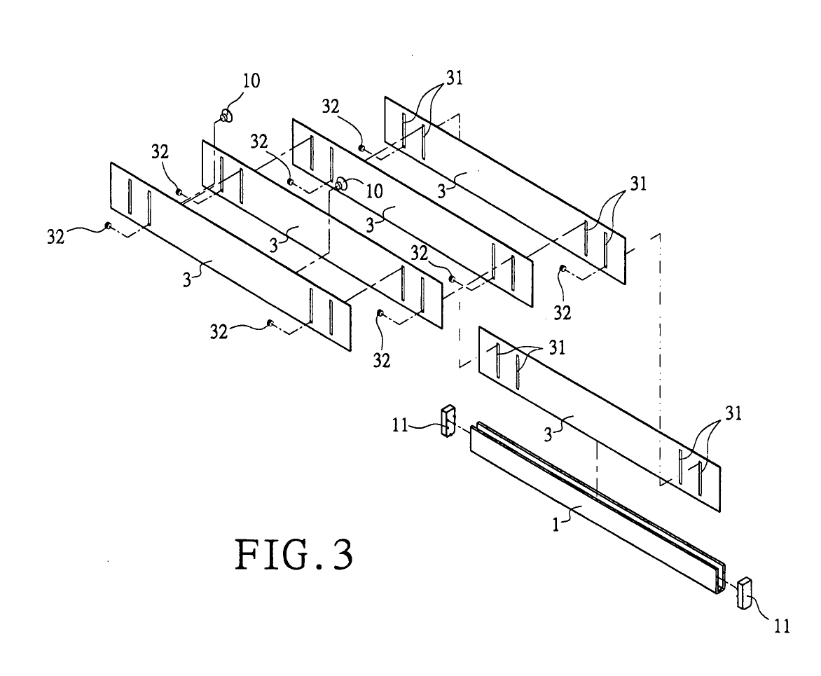

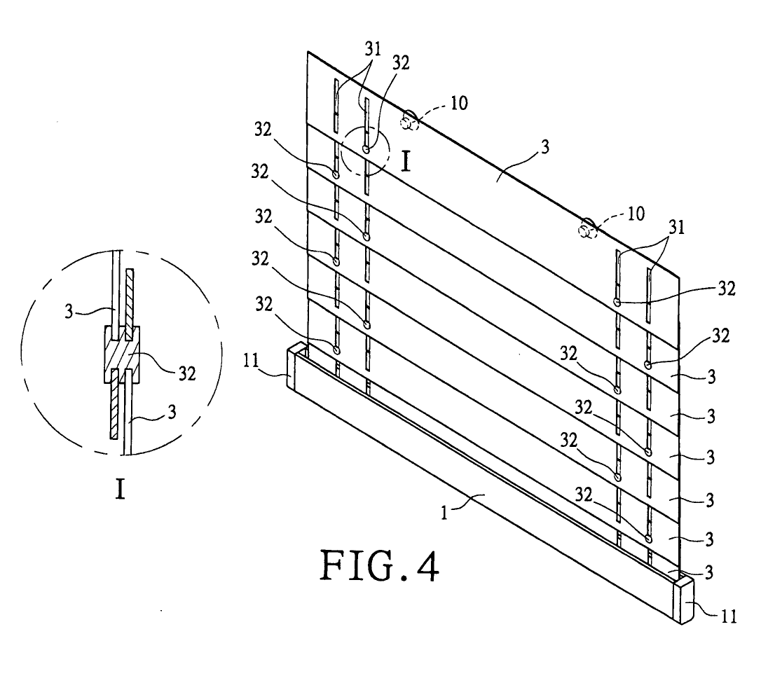

Referring to FIGS. 3 and 4, there is shown a rectangular, foldable shade constructed in accordance with a second preferred embodiment of the invention. The shade comprises a base 1 at one end, a plurality of parallel slats 3, and a plurality of (e.g., two) suction cups 10 fastened at the slat 3 farthest from the base 1. Each component will be described in detail below.

The base 1 is an elongated member having a section of U. The base 1 comprises two caps 11 snapped to sides thereof. The base 1 is formed of a magnetic material so as to be adapted to attract iron, steel, etc. The slat 3 comprises a plurality of (two are shown) longitudinal grooves 31 adjacent either side. The slat 3, except the lowest one, further comprises a plurality of (e.g., two) snapping elements 32. In a folded state, the lowest slat 3 is inserted into the slot of the base 1. For other slats 3, either snapping element 32 of the even numbered slat 3 is fastened at the lowest end of the outer projection 31 thereof and the highest end of the outer projection 31 of the immediate lower slat 3 and either snapping element 32 of the odd numbered slat 3 is fastened at the lowest end of the inner projection 31 thereof and the highest end of the inner projection 31 of the immediate lower slat 3.

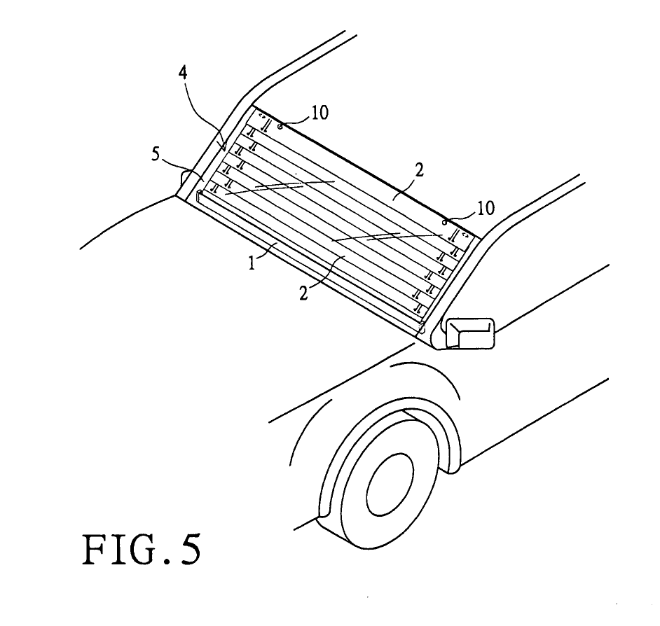

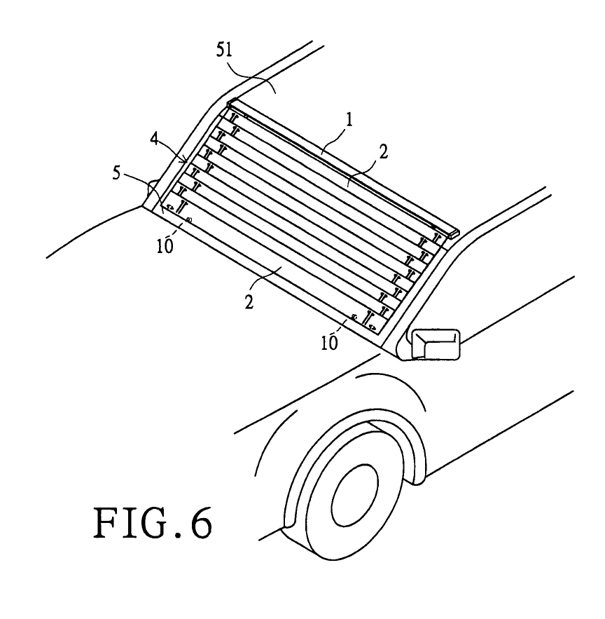

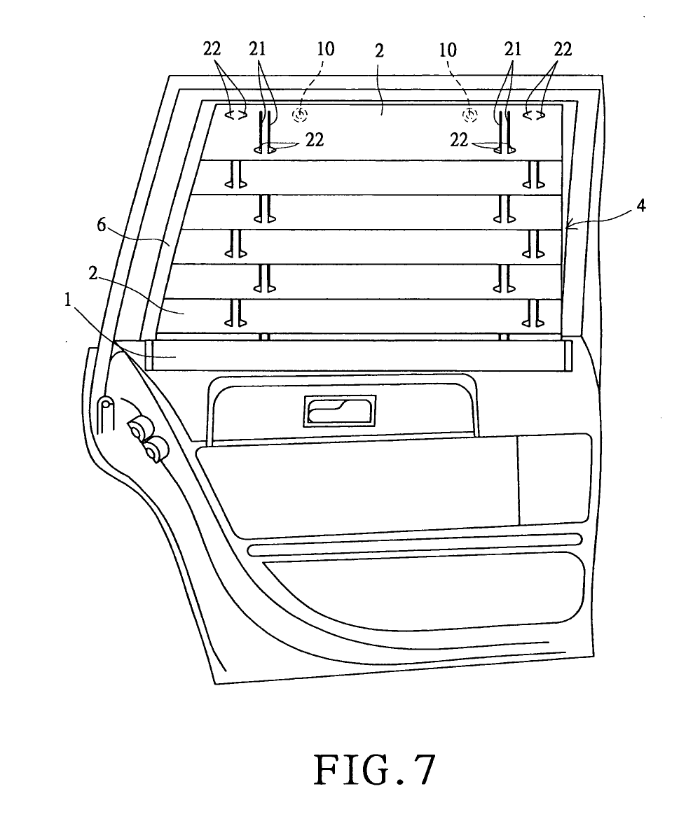

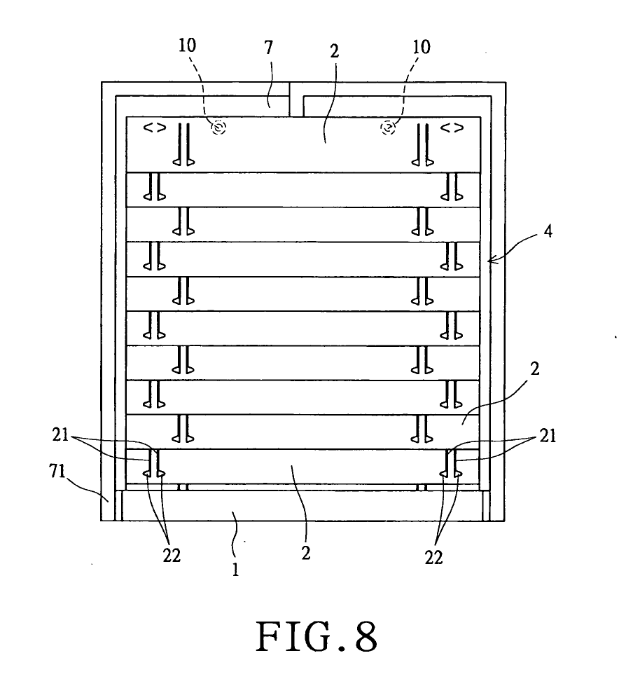

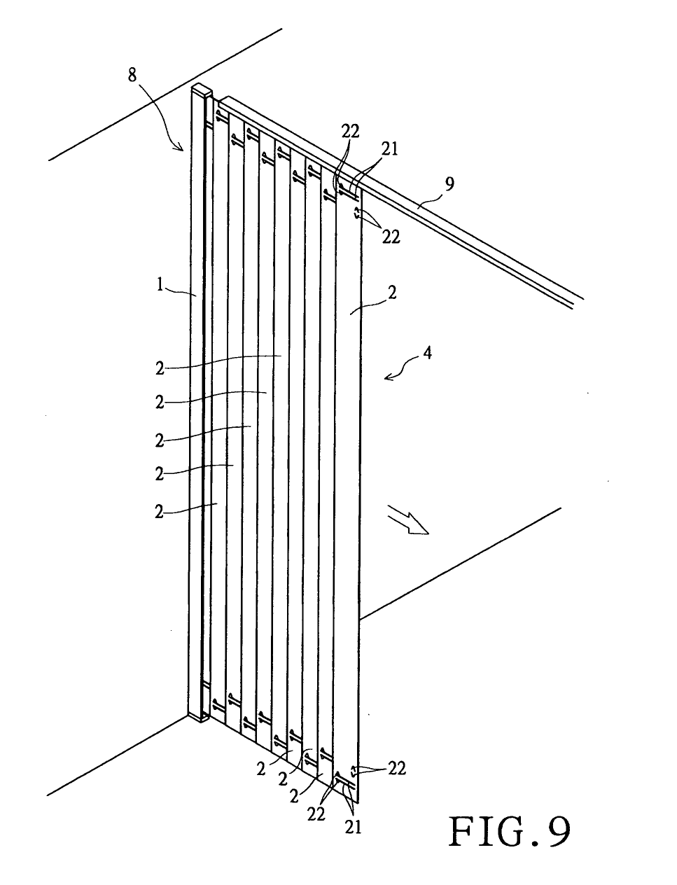

Referring to FIGS. 5 to 9, applications of the shade according to the first preferred embodiment of the invention are shown. As shown in FIG. 5, the shade 4 is mounted on the windshield 5 of an automobile in a first configuration in which the base 1 is adhered to a bottom frame of the windshield 5 by means of adhesive and the topmost slat 2 is adhered to a top thereof by means of the suction cups 10 by pulling the topmost slat 2 upward from a folded state. As shown in FIG. 6, the shade 4 is mounted on the windshield 5 of an automobile in a second configuration in which the base 1 is adhered to a front side of the roof 51 by means of magnetism thereof and the bottommost slat 2 is adhered to a bottom of the windshield 5 by means of the suction cups 10 by pulling the bottommost slat 2 downward from a folded state. As shown in FIG. 7, the shade 4 is mounted on the window 6 of an automobile in which the base 1 is adhered to a bottom frame of the window 6 by means of magnetism thereof and the topmost slat 2 is adhered to a top thereof by means of the suction cups 10 by pulling the topmost slat 2 upward from a folded state. As shown in FIG. 8, the shade 4 is mounted on the window 7 of a house as a window shade in which the base 1 is adhered to a bottom of the frame 71 of the window 7 by means of magnetism thereof and the topmost slat 2 is adhered to a top of the window 7 by means of the suction cups 10 by pulling the topmost slat 2 upward from a folded state. As shown in FIG. 9, the shade 4 is used as an indoor folding partition in which the base 1 is fastened at a wall 8 by means of adhesive, screws or the like and one sides of the slats 2 are received in a grooved rail 9 so that a user can push (or pull) the outermost slat 2 to fold (or extend) the slats 2 along the rail 9.

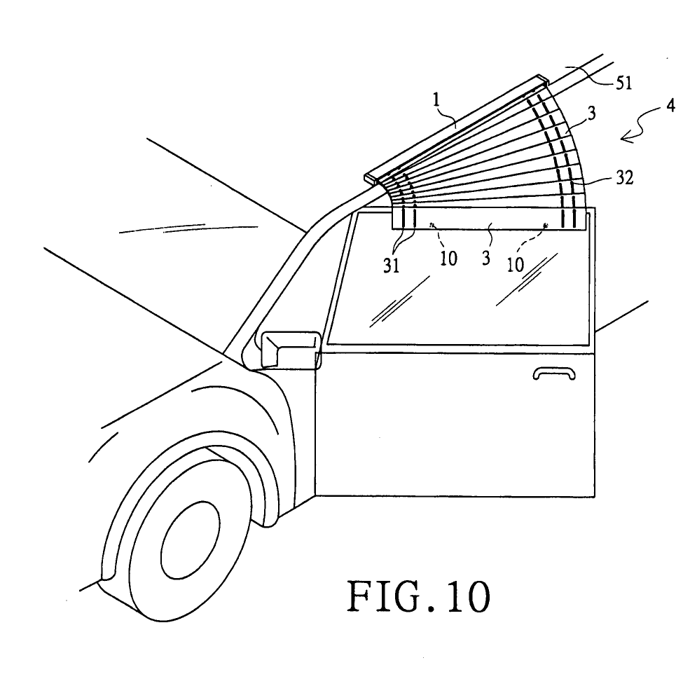

FIG. 10 is an environmental view of the shade 4 according to the second preferred embodiment. As shown, the outermost slat 3 of the shade 4 is adhered to a top of the window above the door by means of the suction cups 10 and the base 1 thereof is adhered to the side of the roof 51 of an automobile. This embodiment is adapted to protect a driver against the rain while entering or leaving the automobile.

While the invention herein disclosed has been described by means of specific embodiments, numerous modifications and variations could be made thereto by those skilled in the art without departing from the scope and spirit of the invention set forth in the claims.

What is claimed is:

1. A foldable shade having a four-sided shape, comprising:
an elongated base formed of a magnetic material having a section of U;
a plurality of parallel slats wherein each of the odd numbered slats includes a plurality of longitudinal grooves adjacent either side, and two pairs of a plurality of projections, each pair being disposed between the grooves and the side, and each of the even numbered slats includes a plurality of longitudinal projections adjacent either side, and two pairs of a plurality of grooves, each pair being disposed between the projections and the side; and
a plurality of suction cups fixedly provided at the slat farthest from the base,
wherein the slat next to the base is inserted therein and in a folded state the grooves of each of the remaining slats are operative to insert in the projections of the immediate next slat proximate the base for engagement.

2. The shade of claim 1, wherein the base comprises two side caps.

3. A foldable shade having a four-sided shape, comprising:
an elongated base formed of a magnetic material having a section of U;
a plurality of parallel slats wherein each slat includes a plurality of longitudinal grooves adjacent either side and each slat except the slat next to the base further includes a plurality of snapping elements; and
a plurality of suction cups fixedly provided at the slat farthest from the base,
wherein the slat next to the base is inserted therein and in a folded state either snapping element of the even numbered slat is fastened at the lowest end of the outer projection thereof and the highest end of the outer projection of the immediate next slat proximate the base and either snapping element of the odd numbered slat is fastened at the lowest end of the inner projection thereof and the highest end of the inner projection of the immediate next slat proximate the base.

4. The shade of claim 3, wherein the base comprises two side caps.
